(19) United States
(12) Patent Application Publication
(10) Pub. No.: US 2010/0296741 A1
(43) Pub. Date: Nov. 25, 2010

(54) FILM SCANNING METHOD

(75) Inventors: Chien-Hsing Tang, Suzhou (CN); Ru-Song Shen, Suzhou (CN)

Correspondence Address: COVENANT IP CONSULTING CO., P.O. BOX 34-306 TAIPEI CITY, TAIPEI, 10499, TW

(73) Assignee: QISDA (SUZHOU) CO., LTD, Suzhou (CN)

(21) Appl. No.: 12/772,225

(22) Filed: May 2, 2010

(30) Foreign Application Priority Data
May 20, 2009 (CN) 200910145271.5

(51) Int. Cl. G06K 9/62

(52) U.S. Cl. 382/216

(57) ABSTRACT

A film scanning method including the following steps is provided. Firstly, a film including an identification code and an image information area is provided, wherein the identification code is disposed on one side of the image information area along a first direction and has a first identification end and a second identification end along a second direction. Next, a location information of the identification code and a sequence information of the first identification end and the second identification end are checked and recorded. Lastly, the scanned image is adjusted along the first direction and the second direction respectively according to the location information and the sequence information. The invention provides the user with convenience in using a film scanning device without using additional elements.

This application claims the benefit of China application Serial No. 200910145271.5, filed May 20, 2009, the subject matter of which is incorporated herein by reference.

### BACKGROUND OF THE INVENTION

1. Field of the Invention

The invention relates in general to a film scanning method, and more particularly to a film scanning method which correct the image scanning direction by recognizing the DX code or characters on the film.

2. Description of the Related Art

It is very hard for the user to determine the scanning direction of the film when scanning a film, and the scanned image obtained in this way may be top-down or left-right inverted and needs to be further processed. Of the technologies that are currently available, some technologies adopt two sensors and determine whether the scanning side is a front side or a rear side on the ground that the front side and the rear side have different ratios of reflectance. However, the structure is more complicated and more costs are required.

### SUMMARY OF THE INVENTION

To resolve the above technical problems, the invention performs optical recognition to the DX code or the digits and the manufacturers printed on the film to determine whether the scanning side is a front side or a rear side, a top side or a bottom side, and the obtained information is used for mirroring the scanned image or turning the scanned image upside down.

The invention provides a film scanning method including the following steps of.

a. Providing a film including an identification code and an image information area, wherein the identification code is disposed in the image information area along a first direction.

b. Checking and recording a location information of the identification code.

c. Adjusting a scanned image along the first direction according to the location information.

A first identification area and a second identification area are used for checking the location of the identification code according to the film scanning method of the invention, and when the location information corresponding to the identification code is located in the second identification area, the scanned image is turned over along the first direction.

According to the film scanning method of the invention, the identification code is a film DX code or characters containing the information of the manufacturer or the date.

The invention further provides a film scanning method including the following steps of.

a. Providing a film including an identification code, wherein the identification code has a first identification end and a second identification end along a second direction.

b. Checking and recording a sequence information of the first identification end and the second identification end.

c. Adjusting a scanned image according to the sequence information along the second direction.

According to the film scanning method of the invention, when the sequence information corresponding to the second identification end is scanned before the first identification end, the scanned image is turned over along the second direction.

According to the film scanning method of the invention, the identification code is a film DX code or characters containing the information of the manufacturer or the date.

The invention further provides a film scanning method including the

a. Providing a film including an identification code and an image information area, wherein the identification code is disposed on one side along the first direction of the image information area and has a first identification end and a second identification end along a second direction.

b. Checking and recording a location information of the identification code and a sequence information of the first identification end and the second identification end.

c. Adjusting the scanned image along the first direction and the second direction respectively according to the location information and the sequence information.

According to the film scanning method of the invention, a first identification area and a second identification area are used for checking the location of the identification code, and when the location information corresponding to the identification code is located in the second identification area, the scanned image is turned over along the first direction.

According to the film scanning method of the invention, when the sequence information corresponding to the second identification end is scanned before the first identification end, the scanned image is turned over along the second direction.

According to the film scanning method of the invention, the identification code is a film DX code or characters containing the information of the manufacturer or the date.

According to the film scanning method of the invention, the checking in the step b is done by the optical characters recognition method.

According to the film scanning method of the invention, between the step b and the step c, the method further includes scanning the film to obtain the scanned image.

The invention provides the user with convenience in using a film scanning device without using additional elements.

The invention will become apparent from the following detailed description of the preferred but non-limiting embodiments. The following description is made with reference to the accompanying drawings.

### BRIEF DESCRIPTION OF THE DRAWINGS

FIG. 1 shows a flowchart of a film scanning method according to an embodiment of the invention;

FIG. 2 shows a flowchart of a film scanning method according to another embodiment of the invention;

FIG. 3 shows a flowchart of a film scanning method according to yet another embodiment of the invention;

FIG. 4 shows a film identification code of an embodiment of the invention;

FIGS. 5A-5D show the adjustments of a scanned image of an embodiment of the invention; and

FIGS. 6-7 show film identification codes of different embodiments of the invention.

### DETAILED DESCRIPTION OF THE INVENTION

To further elaborate the objects, the structure, the features and the functions of the invention, a number of embodiments are disclosed below.

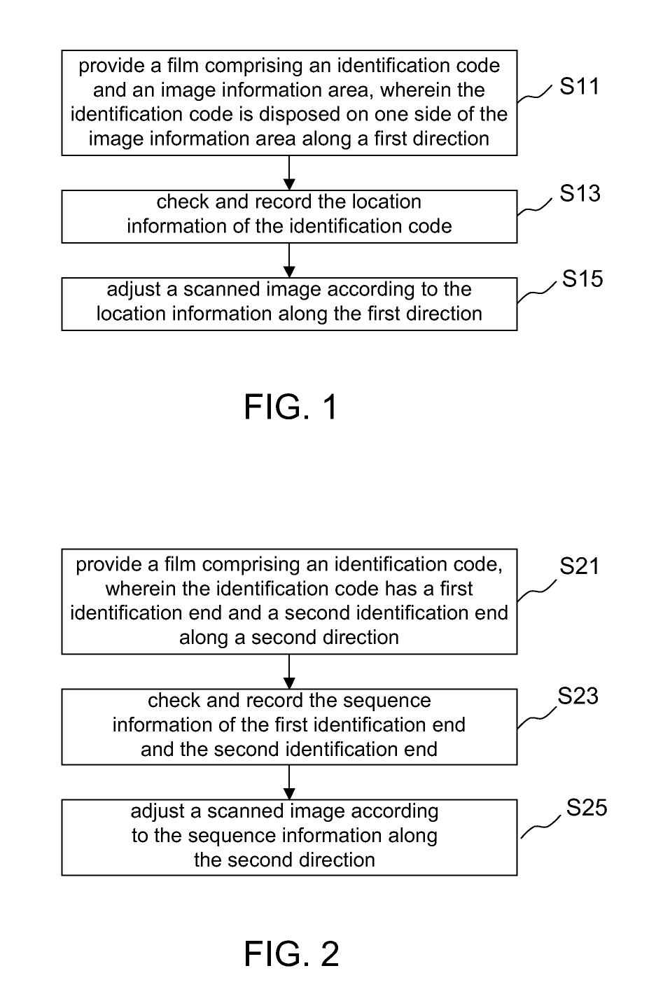

Referring to FIG. 1, a flowchart of a film scanning method according to an embodiment of the invention is shown. The film scanning method includes the following steps. In S11, a film including an identification code and an image information area is provided, wherein the identification code is disposed on one side of the image information area along a first direction. The film can be a positive film or a negative film. The identification code is a film DX code or characters containing the information of the manufacturer or the date. In S13, a location information of the identification code are checked and recorded. In practical application, the checking can be done by optical characters recognition (OCR) method. In S15, the scanned image is adjusted according to the location information along the first direction.

In the present embodiment, a first identification area and a second identification area are used for checking the location of the identification code, and the first identification area and the second identification area correspond to the two sides of the image information area along the first direction. When the location information corresponding to the identification code is located in the second identification area, the scanned image is turned over along the first direction.

In the present embodiment, between the step S13 and the step S15, the method further includes scanning the film to obtain the scanned image. It is noted that the step of scanning the film can be done before or concurrent with the step S13.

Referring to FIG. 2, a flowchart of a film scanning method according to another embodiment of the invention is shown. The film scanning method includes the following steps. In S21, a film including an identification code is provided, wherein the identification code has a first identification end and a second identification end along a second direction. The identification code is a film DX code or characters containing the information of the manufacturer or the date. In S23, a sequence information of the first identification end and the second identification end are checked and recorded. In practical application, the checking can be done by optical characters recognition (OCR) method. In S25, the scanned image is adjusted according to the sequence information along the second direction.

In the present embodiment, when the sequence information corresponding to the second identification end is scanned before the first identification end, the scanned image is turned over along the second direction.

In the present embodiment, between the step S23 and the step S25, the method further includes scanning the film to obtain the scanned image. It is noted that the step of scanning the film can be done be done before or concurrent with the step S23.

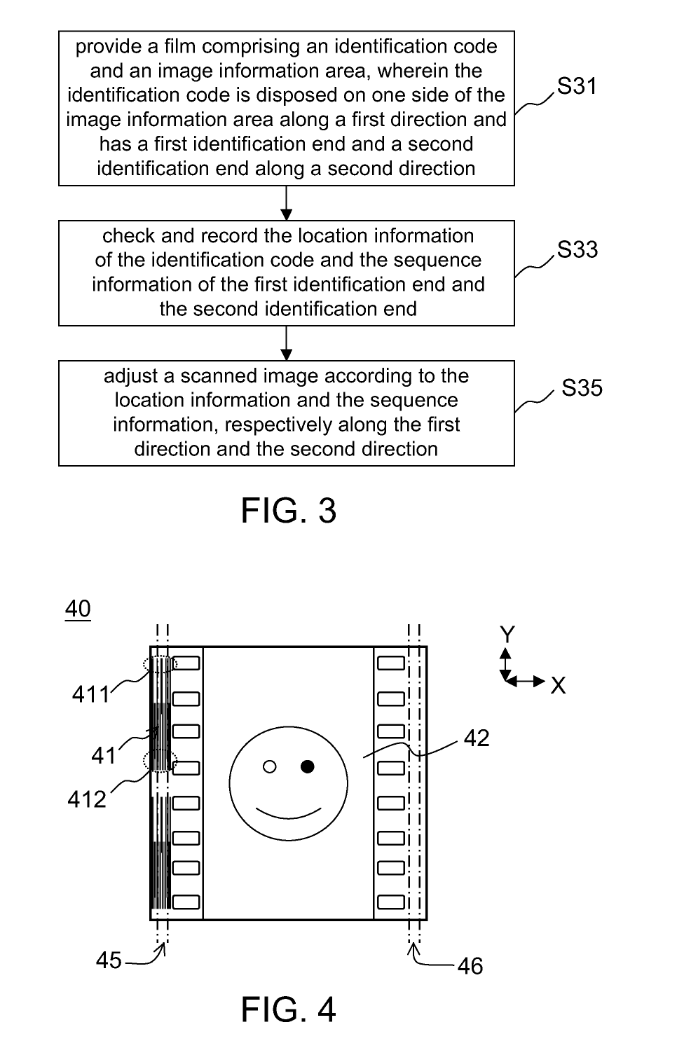

Referring to FIG. 3, a flowchart of a film scanning method according to yet another embodiment of the invention is shown. The film scanning method includes the following steps. In S31, a film including an identification code and an image information area is provided, wherein the identification code is disposed on one side of the image information area along the first direction and has a first identification end and a second identification end along the second direction. The identification code is a film DX code or characters containing the information of the manufacturer or the date. In S33, the location information of the identification code and the sequence information of the first identification end and the second identification end are checked and recorded. In practical application, the checking can be done by optical characters recognition (OCR) method. In S35, the scanned image is adjusted along the first direction and the second direction respectively according to the location information and the sequence information.

In the present embodiment, the first identification area and the second identification area are used for checking the location of the identification code. When the location information corresponding to the identification code is located in the second identification area, the scanned image is turned over along the first direction. When the sequence information corresponding to the second identification end is scanned before the first identification end, the scanned image is turned over along the second direction.

In the present embodiment, between the step S33 and the step S35, the method further includes scanning the film to obtain the scanned image. It is noted that the step of scanning the film can be done be done before or concurrent with the step S33.

Referring to FIG. 4, a film identification code of an embodiment of the invention is shown. The identification code 41 on the film 40 is a DX code, and the information such as film photosensitivity can be inputted to the camera through the DX code, so that the camera can measure the light or expose according to the film photosensitivity. The arrangements of black and white grids denote the film information such as photosensitivity, length and width. Let the film of FIG. 4 be taken for example. The film 40 includes an identification code 41 and an image information area 42, wherein the identification code 41 is disposed at the left-hand side of the image information area 42 (along the X-direction), and has a first identification end 411 and a second identification end 412 along the Y-direction. In practical application, the first identification end 411 may correspond to the film the output end of the DX code, and the second identification end 412 may correspond to the film the input end of the DX code. Also, according to the initial settings of the scanned image by different scanners, the first identification end can be set as an input end of the DX code, and the second identification end can be set as an output end of the DX code.

Referring to FIG. 4, the first identification area 45 and the second identification area 46 are used for checking the location of the identification code 41, wherein the first identification area 45 and the second identification area 46 correspond to the two sides of the image information area 42 along the X direction. In practical application, each of the first identification area 45 and the second identification area 46 includes two checking lines for determining the location of DX code and the proceeding sequence.

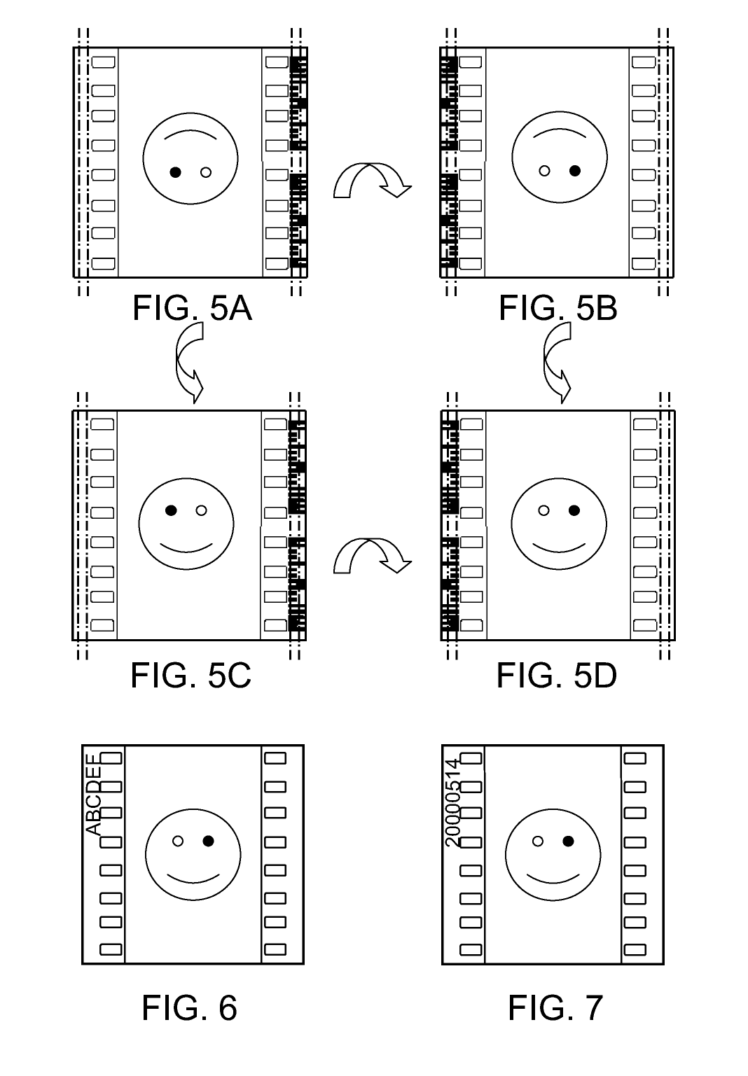

The adjustment of the scanned image is further disclosed in FIGS. 5A-5D. FIGS. 5A-5D show the adjustments of a scanned image of an embodiment of the invention. Assuming that the to-be-scanned film is correctly placed (corresponding to FIG. 5D), the location information corresponding to DX code is located at the left-hand side of the identification area, and the sequence information corresponding to the input end of the DX code is scanned before the output end of the DX code, that is, the input end of the DX code is located under the output end of the DX code. When the user places the to-be-scanned film according to the position illustrated in FIG. 5A, the current location information corresponding to DX code is located at the right-hand side of the identification area, so the scanned image is turned over along the horizontal direction to obtain an image as illustrated in FIG. 5B. The current sequence information is that the input end of the DX code is located above the output end of the DX code, that is, the output end corresponding to the DX code is scanned before the input end of the DX code, so the scanned image is turned over along the vertical direction to obtain an image as illustrated in FIG. 5D. Likewise, the scanned image can be turned over along the vertical direction according to sequence information first so as to obtain an image illustrated in FIG. 5C from the image of FIG. 5A, then the scanned image is turned over along the horizontal direction according to location information to obtain an image as illustrated in FIG. 5D from the image of FIG. 5C. However, the user can place the to-be-scanned film according to the position illustrated in FIG. 5B or FIG. 5C, only one adjustment according to the sequence information or the location information is needed.

For older films lacking of DX code, the invention further recognize characters which are printed on the film and contain the information of the manufacturer or the date such as “ABCDEF” or “20090514” to determine the scanning direction of the film and whether the scanning side is a front side or a rear side according to the location of the characters and the sequence information by optical character recognition method. Referring to FIG. 6 and FIG. 7, different film identification codes of different embodiments of the invention are respectively shown. The principles of the present embodiment of the invention are similar to that of the above embodiments and are not repeated here.

The invention provides the user with great convenience in using the film scanning device. No matter how the user places the to-be-scanned film, the scanned image will not be left-right or top-down inverted. As no additional element is required, no extra cost will incur.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A film scanning method comprising the following steps of:
a. providing a film comprising an identification code and an image information area, wherein the identification code is disposed on one side of the image information area along a first direction;
b. checking and recording a location information of the identification code; and
c. adjusting a scanned image according to the location information along the first direction.

2. The film scanning method according to claim 1, wherein a first identification area and a second identification area are used for checking the location of the identification code, and when the location information corresponding to the identification code is located in the second identification area, the scanned image is turned over along the first direction.

3. The film scanning method according to claim 1, wherein the identification code is a film DX code or characters containing the information of the manufacturer or the date.

4. A film scanning method, comprising the following steps of:
a. providing a film comprising an identification code, wherein the identification code has a first identification end and a second identification end along a second direction;
b. checking and recording a sequence information of the first identification end and the second identification end ;
c. adjusting a scanned image according to the sequence information along the second direction.

5. The film scanning method according to claim 4, wherein when the sequence information corresponding to the second identification end is scanned before the first identification end, the scanned image is turned over along the second direction.

6. The film scanning method according to claim 4, wherein the identification code is a film DX code or characters containing the information of the manufacturer or the date.

7. A film scanning method, comprising the following steps of:
a. providing a film comprising an identification code and an image information area, wherein the identification code is disposed on one side of the image information area along a first direction and has a first identification end and a second identification end along a second direction;
b. checking and recording a location information of the identification code and a sequence information of the first identification end and the second identification end;
c. adjusting a scanned image along the first direction and the second direction respectively according to the location information and the sequence information.

8. The film scanning method according to claim 7, wherein a first identification area and a second identification area are used for checking the location of the identification code, and when the location information corresponding to the identification code is located in the second identification area, the scanned image is turned over along the first direction.

9. The film scanning method according to claim 7, wherein when the sequence information corresponding to the second identification end is scanned before the first identification end, the scanned image is turned over along the second direction.

10. The film scanning method according to claim 7, wherein the identification code is a film DX code or characters containing the information of the manufacturer or the date.

11. The film scanning method according to claim 7, wherein the step b is done by the optical characters recognition method.

12. The film scanning method according to claim 7, wherein, between the step b and the step c, the method further comprises the step of scanning the film to obtain the scanned image.
